(19) United States
(12) Patent Application Publication
(10) Pub. No.: US 2017/0353870 A1
(43) Pub. Date: Dec. 7, 2017

(54) ANTENNA BEAMS IN A WIRELESS SYSTEM

(71) Applicant: Nokia Solutions and Networks Oy, Espoo (FI)

(72) Inventors: Marcin RYBAKOWSKI, Rawicz (PL); Krystian SAFJAN, Nowy Sacz (PL)

(21) Appl. No.: 15/537,350

(22) PCT Filed: Dec. 18, 2014
(86) PCT No.: PCT/EP2014/078355

§ 371 Date: Jun. 16, 2017

(51) Int. Cl. H04W 16/28; H04B 7/024; H04B 7/06; H04B 7/08

(52) U.S. Cl. CPC H04W 16/28; H04B 7/0842; H04B 7/024; H04B 7/0617; H04B 7/0634

(57) ABSTRACT

Methods and apparatus for wireless communications via antenna beams are disclosed. Information identifying at least one antenna beam used by an access point for communication with a device is sent to at least one other access point. The other access point can use the information as assistance in selecting, based at least in part on the information, at least one antenna beam for use in wireless communication with the device.

This disclosure relates to wireless communication and more particularly to wireless communication via antenna beams.

A communication system can be seen as a facility that enables communication between two or more nodes such as fixed or mobile communication devices, access points such as base stations, servers, machine-type devices and so on. A communication system and compatible communicating entities typically operate in accordance with a given standard or specification which sets out what the various entities associated with the system are permitted to do and how that should be achieved. For example, the standards, specifications and related protocols can define the manner how communications between communication devices and the access points shall be arranged, how various aspects of the communications shall be provided and how the equipment shall be configured.

Signals can be carried on wireless carriers. Examples of wireless systems include public land mobile networks (PLMN) such as cellular networks, satellite based communication systems and different wireless local networks, for example wireless local area networks (WLAN). Wireless systems can be divided into coverage areas referred to as cells, and hence the wireless systems are often referred to as cellular systems. A base station can provide one or more cells, there being various different types of base stations and cells. In modern radio communication networks, such as the Long Term Evolution (LTE) or the LTE-Advanced (LTE-A) of the 3rd Generation Partnership Project (3GPP), common base stations (often called as Node B; NB or enhanced Node B; eNB) are used.

A user can access the communication system and communicate with other users by means of an appropriate communication device or terminal. Communication apparatus of a user is often referred to as a user equipment (UE). Typically a communication device is used for enabling receiving and transmission of communications such as speech and data. A communication device is provided with an appropriate signal receiving and transmitting arrangement for enabling communications.

To satisfy the increasing capacity demand use of millimeter wave (mmWave) spectrum for wireless communications has been proposed. For example, the future 5th generation (5G) wireless systems are envisioned to operate also in the millimeter wave spectrum. Millimeter wave systems are planned to be operated in >30 GHz frequency bands. High signal frequency can result in high propagation loss. To compensate for large propagation loss systems operated on millimeter wave spectrum use high gain antennas.

A possibility to provide high gain antennas is formulation of narrow beam antenna characteristics. Access points (APs) can use active antenna arrays for communication with communication devices such as the user equipment (UE). The active antenna arrays can dynamically form and steer narrow transmission/reception beams and serve multiple UEs and track their positions based on UE-specific beamforming. The active antenna arrays may be used both at the access point and at the user equipment to further enhance the beamforming potential.

The mmWave systems are anticipated to use large transmission bandwidth, e.g. bandwidths in the order of 1 GHz-2 GHz. Because of this analog to digital converters (ADC) and digital to analog converters (DAC) used for the transmissions need to operate with high sampling frequency. High sampling frequency of converters operating in mmWave bands can result high power consumption. High power consumption and expensive technologies may limit the usage of digital beamforming techniques where one ADC/DAC converter is connected to every antenna element in an antenna array. Because of this currently preferred radio frequency (RF) beamforming techniques use only one ADC for reception (RX) path and one DAC for transmission (TX) path per polarization for all antenna elements in an antenna array.

The RF beamforming however can require special techniques for alignment of antenna beams between an AP and a UE. RF beamforming typically comprises searching through all possible beam directions to identify the optimum beam which can be more time consuming than angle of arrival estimation techniques that are possible with digital beamforming. The lengthy search can be problematic e.g. in providing handover (HO) of a user equipment between access points.

It is noted that the above discussed issues are not limited to any particular communication environment and station apparatus but may occur in any appropriate system where communications may be provided via antenna beams.

Embodiments of the invention aim to address one or several of the above issues.

In accordance with an embodiment there is provided a method for wireless communications, comprising sending information identifying at least one antenna beam used by an access point for wireless communication with a device to at least one other access point to be used by the at least one other access point in selection of at least one antenna beam for wireless communication with the device.

In accordance with an embodiment there is provided a method for wireless communications, the method comprising receiving at an access point information identifying at least one antenna beam used by another access point for wireless communication with a device, and selecting, based at least in part on said information, at least one antenna beam for use in wireless communication between the access point and the device.

In accordance with an embodiment there is provided a method in association with handover of a device from a source access point to a target access point, the method comprising storing information at the device of at least one antenna beam used for communication with the source access point, and selecting at least one antenna beam for communication with the target access point based on the stored information.

In accordance with an embodiment there is provided an apparatus for wireless communications, the apparatus comprising at least one processor, and at least one memory including computer program code, wherein the at least one memory and the computer program code are configured, with the at least one processor, to cause sending information identifying at least one antenna beam used by an access point for wireless communication with a device to at least one other access point to be used by the at least one other access point in selection of at least one antenna beam for wireless communication with the device.

In accordance with an embodiment there is provided an apparatus for wireless communications, the apparatus comprising at least one processor, and at least one memory including computer program code, wherein the at least one memory and the computer program code are configured, with the at least one processor, to process information identifying at least one antenna beam used by an access point for wireless communication with a device, and select, based at least in part on said information, at least one antenna beam for use in wireless communication between another access point and the device.

In accordance with an embodiment there is provided a communication device configured to communicate with at least one other node information identifying at least one antenna beam for use in antenna beam selection.

In accordance with a yet another embodiment there is provided a communication device comprising at least one memory for storing information of at least one antenna beam used for communication with a source access point involved in handover of the communication device to a target access point, and a processor for selecting at least one antenna beam for communication with a target access point based on the stored information.

In accordance with a more specific aspect a record associating antenna beams of at least two access points is generated and/or updated. A handover may be provided to a target access point and the record updated based on information of the handover. The record may comprise a table linking beam identities of at least two neighbouring access points.

In accordance with a specific aspect information identifying at least one antenna beam is communicated between source and target access points in association with handover of a device between the source and target access points. Selection of at least one antenna beam may comprise selection of at least one antenna beam based on information identifying antenna beams and associating at least one antenna beam of the source access point with at least one promising candidate antenna beam of the target access point.

The access points may operate in millimeter wave spectrum.

A computer program comprising program code means adapted to perform the herein described methods may also be provided. In accordance with further embodiments apparatus and/or computer program product that can be embodied on a computer readable medium for providing at least one of the above methods is provided.

A network node such as an access point, a base station, a mobile station, a controller for an access system or a controller for core network may be configured to operate in accordance with at least some of the embodiments. A communications device adapted for the operation can also be provided. A communication system embodying the apparatus and principles of the invention may also be provided.

It should be appreciated that any feature of any aspect may be combined with any other feature of any other aspect.

Embodiments will now be described in further detail, by way of example only, with reference to the following examples and accompanying drawings, in which:

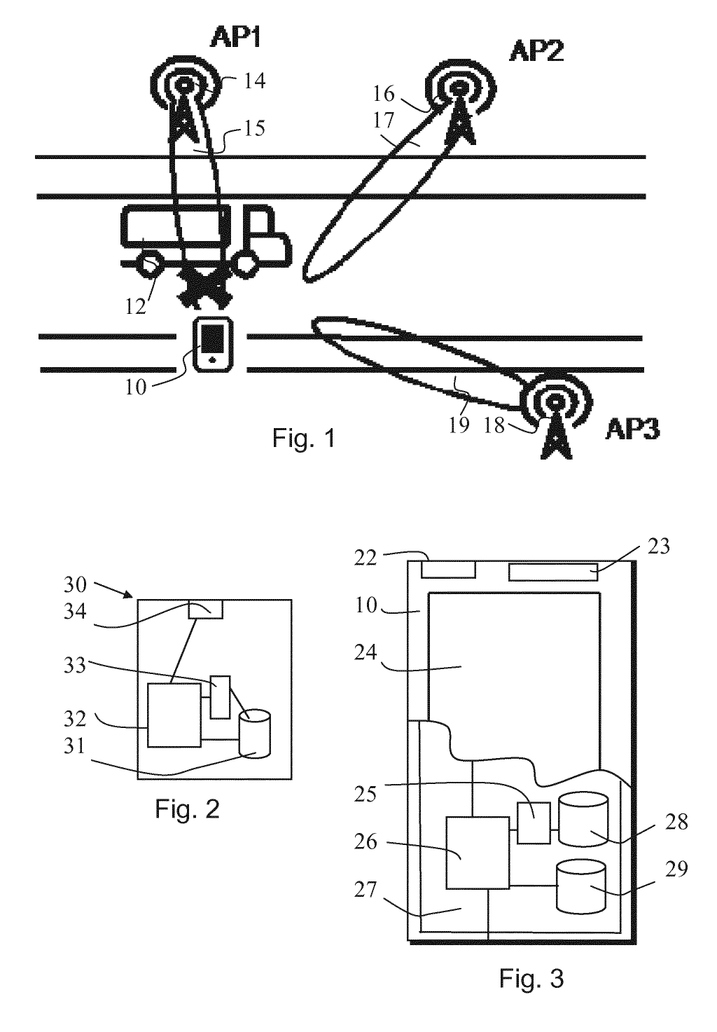

FIG. 1 shows a schematic diagram of a wireless system where certain embodiments can be implemented;

FIG. 2 shows a schematic diagram of a control apparatus according to some embodiments;

FIG. 3 shows a schematic presentation of a possible communication device;

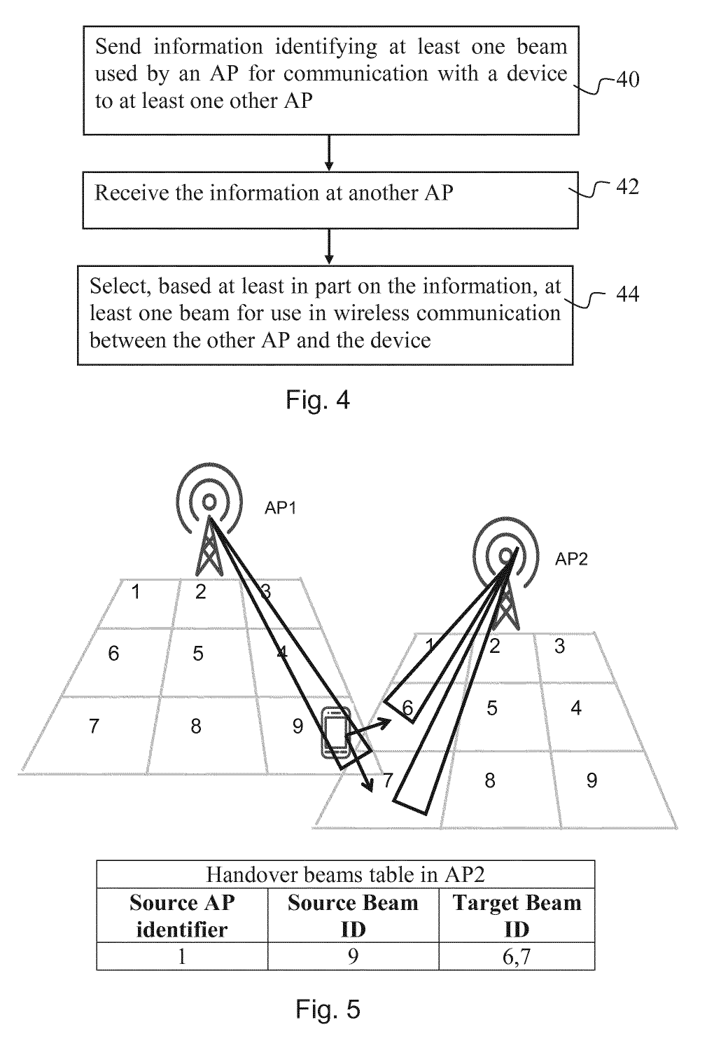

FIG. 4 is a flowchart according to an example;

FIG. 5 shows an example of handover of a device;

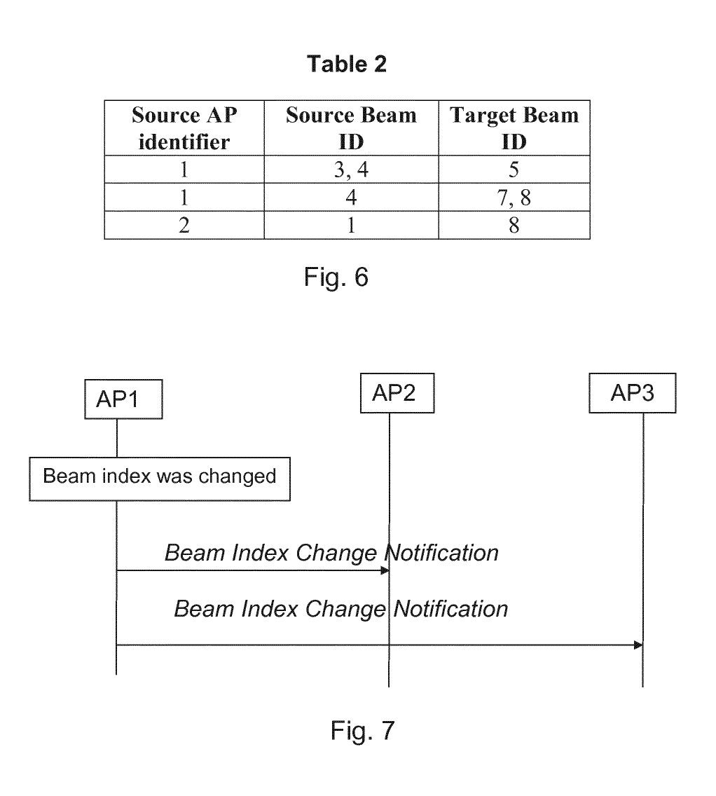

FIG. 6 shows an example of a handover assistance table; and

FIGS. 7 to 9 are examples of various signaling processes in accordance with a specific example.

In the following certain exemplifying embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

A non-limiting example of communication system architectures is the long-term evolution (LTE) of the Universal Mobile Telecommunications System (UMTS) that is being standardized by the 3rd Generation Partnership Project (3GPP). The LTE employs a mobile architecture known as the Evolved Universal Terrestrial Radio Access Network (E-UTRAN). Access point are provided by base stations which in such systems are known as evolved or enhanced Node Bs (eNodeBs; eNBs) and may provide E-UTRAN features such as user plane Radio Link Control/Medium Access Control/Physical layer protocol (RLC/MAC/PHY) and control plane Radio Resource Control (RRC) protocol terminations towards communication devices. Other examples of radio access system include those provided by base stations of systems that are based on technologies such as wireless local area network (WLAN) and/or WiMax (Worldwide Interoperability for Microwave Access).

A communication device 10 or terminal can be provided wireless access via base stations or similar wireless transmitter and/or receiver nodes providing access points of a radio access system. FIG. 1 shows three access points 14, 16 and 18 but it is noted that these are shown only for illustration purposes and that a larger or smaller number of base stations or other access points may be provided in a network.

Each of the access points is shown to provide at least one antenna beam 15, 17 and 19 directed in the direction of the communication device 10. The antenna beam can be provided by appropriate elements of antenna arrays of the access points. For example, access links between the access points (AP) and a user equipment (UE) can be provided by active antenna arrays. Such arrays can dynamically form and steer narrow transmission/reception beams and thus serve UEs and track their positions. This is known as UE-specific beamforming. The active antenna arrays can be used both at the AP and at the UE to further enhance the beamforming potential. More than one beam can be provided by each access point and/or antenna array.

Access points and hence communications there through are typically controlled by at least one appropriate controller apparatus so as to enable operation thereof and management of mobile communication devices in communication therewith. FIG. 2 shows an example of a control apparatus for a node, for example to be integrated with, coupled to and/or otherwise for controlling any of the access points of FIG. 1. The control apparatus 30 can be arranged to provide control on communications via antenna beams by the access points and on operations such as handovers between the access points. For this purpose the control apparatus comprises at least one memory 31, at least one data processing unit 32, 33 and an input/output interface 34. Via the interface the control apparatus can be coupled to relevant other components of the access point. The control apparatus can be configured to execute an appropriate software code to provide the control functions. It shall be appreciated that similar components can be provided in a control apparatus provided elsewhere in the network system, for example in a core network entity. The control apparatus can be interconnected with other control entities. The control apparatus and functions may be distributed between several control units. In some embodiments, each base station can comprise a control apparatus. In alternative embodiments, two or more base stations may share a control apparatus.

Access points and associated controllers may communicate with each other via fixed line connection and/or air interface. The logical connection between the base station nodes can be provided for example by an X2 interface. This interface can be used for example for coordination of operation of the stations.

The communication device 10 may comprise any suitable device capable of at least receiving wireless communication of data. For example, the device can be handheld data processing device equipped with radio receiver, data processing and user interface apparatus. Non-limiting examples include a mobile station (MS) such as a mobile phone or what is known as a ‘smart phone’, a portable computer such as a laptop or a tablet computer provided with a wireless interface card or other wireless interface facility, personal data assistant (PDA) provided with wireless communication capabilities, or any combinations of these or the like. Further examples include wearable wireless devices such as those integrated with watches or smart watches, eyewear, helmets, hats, clothing, ear pieces with wireless connectivity, jewelry and so on, universal serial bus (USB) sticks with wireless capabilities, modem data cards, machine type devices or any combinations of these or the like.

FIG. 3 shows a schematic, partially sectioned view of a possible communication device. More particularly, a handheld or otherwise mobile communication device 1 is shown. A mobile communication device is provided with wireless communication capabilities and appropriate electronic control apparatus for enabling operation thereof. Thus the mobile device 1 is shown being provided with at least one data processing entity 26, for example a central processing unit and/or a core processor, at least one memory 28 and other possible components such as additional processors 25 and memories 29 for use in software and hardware aided execution of tasks it is designed to perform. The data processing, storage and other relevant control apparatus can be provided on an appropriate circuit board 27 and/or in chipsets. Data processing and memory functions provided by the control apparatus of the mobile device are configured to cause control and signaling operations in accordance with certain embodiments of the present invention as described later in this description. For example, a processor and a memory can be configured for storing and/or communication of information relating to the antenna beam identities before, during and/or after handover. A user may control the operation of the mobile device by means of a suitable user interface such as touch sensitive display screen or pad 24 and/or a key pad, one of more actuator buttons 22, voice commands, combinations of these or the like. A speaker and a microphone are also typically provided. Furthermore, a mobile communication device may comprise appropriate connectors (either wired or wireless) to other devices and/or for connecting external accessories, for example hands-free equipment, thereto.

The mobile device may communicate wirelessly via appropriate apparatus for receiving and transmitting signals. FIG. 3 shows schematically a radio block 23 connected to the control apparatus of the device. The radio block can comprise a radio part and associated antenna arrangement. The antenna arrangement may be arranged internally or externally to the mobile device. The antenna arrangement may comprise elements capable of beamforming operations. Beamforming may be provided for transmitting, receiving or both.

The following example is given in relation handovers between mmWave access points/base stations. A characteristic of radio wave propagation in mmWave is high level of attenuation by obstacles and large diffraction loss. This can mean that obstacles such trees, cars, humans and other obstacles that may be present in a typical use environment can cause considerable attenuation of radio waves. The attenuation can be many times greater than 20 dB. This effect is even more severe due the fact that with large antenna arrays the antenna beamwidth can be relatively narrow. This can cause a complete radio link failure between an AP and a UE. In case of signal blockage by an obstacle the beamforming procedure needs to find a different beam pair for communications between an AP and a UE. For example, the antenna beams can be redirected so that signal transmission is maintained by reflection of radio waves when line of sight (LOS) path is blocked. Otherwise handover procedure to a neighbour AP shall be performed. Redirection may not always possible, for example because of the propagation environment. Even if redirection is possible the signal strength can be much lower due to reflection loss, and handover to another cell would be a preferred option.

A consequence of the characteristics of mmWave propagation is, because of usage of large antenna arrays and RF beamforming, that handover (HO) rates in mmWave systems can be much higher than e.g. in centimeter wave systems. For example, handover may need to take place in a moving car in about once 1-2 second, for a pedestrian in every 3-11 seconds and in certain use scenarios in intervals less than one second. Thus in mmWave systems handover (HO) operation is expected to be triggered relatively often.

FIG. 1 illustrates how a moving obstacle 12, e.g. a motor vehicle, can easily attenuate strongly the signal from a serving cell or access point 14, called below AP1, to a communication device 10, called below UE. This can cause a radio link failure, or a considerably reduction in quality of service (QoS). This requires that a handover should be performed to another cell, or target access point 16 or 18, called below AP2 or AP3, as quickly as possible from the source cell 14. A requirement for a successful handover is efficient beamforming procedures in the source and target cells during the handover procedure.

A limitation of RF beamforming is that target access points (AP2 and AP3 in FIG. 1) may not be able to find quickly enough optimal antenna beam direction towards the UE due to large number of possible beam directions. For example, for access point steering range +/−45 degrees with 2.5 degree step, both in vertical and horizontal plane, there are 1296 possible beam directions already on the AP side. This requires sweeping the beams and exchanging information between the UE and the AP about beam alignment. Generally speaking, the handover (HO) procedure in these circumstances may require almost the same target cell detection procedure as in case of initial access of the UE to the mmWave AP. The cell detection process is quite time consuming and therefore the high HO intervals may cause problems.

The following describes an example for efficient beam alignment procedure between the UE and AP2 when the UE is changing serving AP1 to the other access point AP2. RF beamforming comprises searching through all possible beam directions to identify the optimum beam which can be time consuming. The proposed RF beamforming algorithm aims to reduce the searching time of beamforming in such case. Need of the RF beamforming procedure to search through all possible beam directions to identify the optimum beam selection of promising beam candidate or candidates is avoided by a selection mechanism that uses information exchanged between the access points about possible beams. The information identifies particular beams used for communication with a device. Based on the information it can be determined which beam/beam direction to use for communications after handover.

The flowchart of FIG. 4 illustrates the principle. In accordance with a method for wireless communication an access point sends at 40 information identifying at least one antenna beam used by the access point for communication with a device. The at least one antenna beam can be provided e.g. by an active antenna array. The information is send to be used by the at least one other access point in selection of at least one antenna beam for wireless communication with the device.

Another access point receives the information at 42, and can use the information at 44 in selecting, based at least in part on said information, at least one antenna beam for use in wireless communication between it and the device.

According to an embodiment information about antenna beam identities can be exchanged between a source AP and target AP. The target AP can create a record, for example a table, of most likely target antenna beams for beam alignment with UE coming from a source AP. In accordance with an example for the table is provided for assisting handovers. Creation and/or updating appropriate beam identifiers such as beam indices associated with antenna beams of an access point will be described in more detail below.

A mechanism for selecting appropriate beam(s) in an access point can be based on recorded beam indexes. For example, a source access point can send its beam index information to a target access point during handover so that the target access point may determine a starting beam in its beamforming procedure. To determine the starting beam, a procedure may be used where the target access point generates a mapping between source access point beam index and target access point beam index by storing and calculating the most likely source access point and target access point beam index pairs after successful handovers.

The procedure of providing assistance in beam selection can be divided into stages. Handover table creation and/or updating based on historic data can be seen a stage. Use of the table for actually providing assistance in beamforming can be seen as a second stage of operation.

FIG. 5 shows a more detailed example where an UE moves from area of AP1 to area of AP2. Thus the UE is handed over from AP1 to AP2. Areas 1 to 9 in each service area of the access point correspond to the identities of beams serving those areas. These beam identities are then used in “the handover beams table in AP2” also shown in the Figure.

As shown by the table, only a limited set of beams is available for use by access points AP1 and AP2 for communication with the UE 10 moving from a particular location to neighbouring locations at the area of AP2 and thus handing over between the access points AP1 and AP2. More particularly, only a relatively small subset of all possible beam combinations is feasible for the handover. Thus only a limited subset of beams needs to be considered during the handover of the mobile device 10 served with a source beam ID=9 of AP1 from AP1 to AP2.

In accordance with the table for AP2 devices that came from AP1 and were last served with beam ID=9 of AP1 can be taken over by predefined beams of AP2. The predefined beams are determined based on assumption made on the basis of historical data of previous handovers that devices from particular cell and beam can be served by particular beam or beams of AP2. In the example this would be beam ID=6 or ID=7, as shown by the table. Selection of one of these can be based on a further criteria such as radio link strength quality or service, priority.

Identifying beams of an access point can be based on a proprietary solution. The identification of antenna beams in a particular access point can be provided in various manners. What is important is that the beams of an access point can be distinguished by potential handover target access points.

An established identification arrangement for all antenna beams in an AP is preferably relatively static during network operation. Once established the identities, e.g. based on beam indexing, for a particular AP should not be changed during network operation without informing the neighbour APs about the change. Changes in the indexing may be required for example because another antenna array was installed in the AP, a new AP with new different antenna was installed in the area, a new sector with additional antenna is installed in the AP and so on. Also, new beamforming procedures may be applied in the UE which can change the number of antenna beams used. If a change is needed then information thereof should be signaled to the neighboring access points for updating the records maintained therein. Information maintained in an access point can be updated repeatedly.

An example of signalling information exchange for informing beam indexing change is shown in FIG. 7. The message is depicted in FIG. 7 as ‘Beam Index Change Notification’. Such as message may require standardization for enhancing interoperability.

The source AP in HO preparation phase is aware of the current antenna beam used for communication between UE and the source AP. Thus the source AP can send beam index information in the HO procedure to the target AP. This exchange of information can be standardized in order to allow for easier interworking of APs from various vendors.

The potential target AP saves the beam index information from the particular source AP together with information about its own beam index which was used during HO procedure, and/or immediately after it, for communication with the UE. The target AP can be arranged to save continuously beam information received from source APs and can thus create a record comprising information of most likely combinations of source beam indexes from source APs and its own beam indexes. Such record is illustrated by Table 2 of FIG. 6 showing an example of a table with list of source and target beam indexes collected in target AP2.

The table at an access point (AP) can be continuously updated. When update is finished the target AP has a list of most probable target beam IDs. This list can be used to enhance and speed up the process of antenna beam alignment in HO procedures.

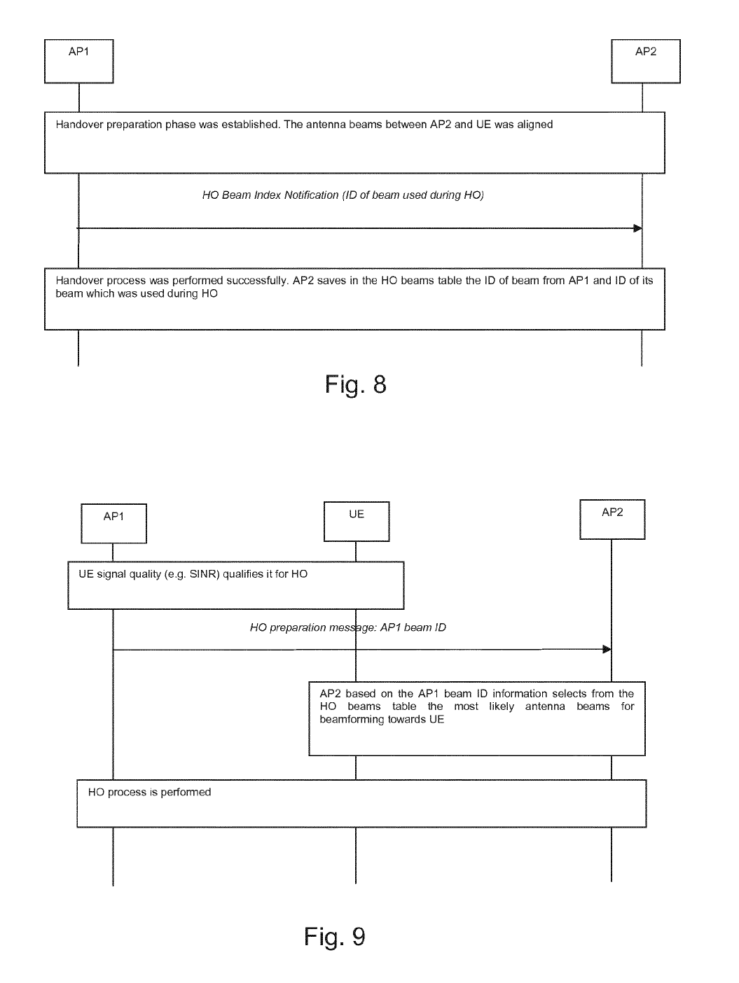

FIG. 8 shows an example for signalling procedure for informing neighbouring access points about beam index and use thereof for communications for updating a handover record in one or more access points. In this example AP1 informs AP2 about ID of antenna beam used during a HO. The message is depicted in FIG. 8 as ‘HO Beam Index Notification’. If the handover process was successful AP2 saves the beam ID received from AP1 in the HO beam table such that it is associated with ID of its beam.

The generated beamforming assistance information can then be used for example as follows. When a source AP in HO preparation phase sends information identifying the antenna beam (e.g. the index) it currently uses for communications between the UE and the AP to all neighbour access points, a target neighbour access point(s) can select the most likely target beam ID from the table or other record based on the pairing of the source beam ID(s) and target beam ID(s). Selection based on historic data can speed up the beam training procedure in the HO process and can improve the HO time execution. It may also decrease HO fail ratio.

The table can contain a number of beams for a particular source AP. For example in Table 2 an UE with the source beam ID 3 or 4 from source AP 1 is most likely to handover to target beam ID 5.

The target beam ID indicated for selection can be the most often used beam during beamforming procedures to enhance and speed up the process of target cell detection and HO procedures.

Certain aspect of use of beamforming assistance during HO with the usage of HO beams table may require standardization for ensuring better interoperability. An example of use of beamforming assistance during HO based on HO beam table is shown in FIG. 9. In this example the AP1 informs AP2 about AP1 antenna beam ID used for communication with the UE which fulfils HO criteria. Standardization may be required for the message depicted in FIG. 9 as ‘HO preparation message: AP1 beam ID’. The AP2 can select most likely antenna beams based on this information and HO beams table which can be aligned towards UE and use those beams during process of UE detection.

Although the above was presented for the case of a cellular system operated on mmWaves, e.g. in relation to communications on 30-300 GHz frequencies, similar characteristics and issues may be expected at least for certain degree for systems operated on other frequencies. Overall, the higher order of antenna arrays used more severe problems may be expected. For high frequencies typically large antenna arrays are envisioned.

In the above examples information about beams is exchanged between access points such as base stations. It is also possible for a communication device, for example a mobile device, to exchange and/or utilize information regarding antenna beams. For example, a mobile device can send information regarding identities of beams of measured access points. Also, a mobile device can comprise smart antenna and thus provide beamforming capability. Such a mobile device may need to communicate information regarding beams provided by its antenna array. A mobile device may also provide an access point for other devices.

An example relates to handover of a communication device, for example a mobile station, from a source access point to a target access point. Information of at least one antenna beam used for communication with the source access point (reception and/or transmission) can be stored at the communication device, for example in one of memories 28 or 29 of FIG. 3. At least one antenna beam for communication with the target access point (transmission and/or reception) can then be selected based on the stored information.

In accordance with a possibility a mapping can be generated for a beamforming setting in a receiver of a node from the beamforming setting in a transmitter of another node. For example, information identifying at least one transmitter beam can be communicated between an access point and a communication device. The node receiving the information can be configured to be capable of determining appropriate at least one beam for reception based at least in part on the information.

The beams identified and/or selected in various embodiments may be for transmission and/or reception.

In a smart antenna arrangement the beams can be provided based on beamforming settings, and thus a reference to an antenna beam can be understood also to mean a beamforming setting. It is appreciated that directional antenna beams can also be formed otherwise.

To give an example of a possible efficiency improvement scenario a reference is made to the number of possible beams in AP presented above (1296 possible beams). If a large variation in source to target beam mapping is assumed (e.g. from given source beam there can be transition to 1 (optimistic)-13 (pessimistic) different beams in target cell), it may be possible to achieve 1000×-100× times reduction of beams to check (1 or 13 preselected beams) when compared to the blind search.

The required data processing apparatus and functions of a network elements such as base station apparatus and other access points and controller elements, a communication device, a core network element and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims. Indeed there is a further embodiment comprising a combination of one or more of any of the other embodiments previously discussed.

1. A method for wireless communications, comprising:
sending information identifying at least one antenna beam used by an access point for wireless communication with a device to at least one other access point to be used by the at least one other access point in selection of at least one antenna beam for wireless communication with the device.

2. A method for wireless communications, comprising:
receiving at an access point information identifying at least one antenna beam used by another access point for wireless communication with a device, and
selecting, based at least in part on the information, at least one antenna beam for use in wireless communication between the access point and the device.

3.-8. (canceled)

9. An apparatus for wireless communications, the apparatus comprising at least one processor, and at least one memory including computer program code, wherein the at least one memory and the computer program code are configured, with the at least one processor, to cause the apparatus to:
send information identifying at least one antenna beam used by an access point for wireless communication with a device to at least one other access point to be used by the at least one other access point in selection of at least one antenna beam for wireless communication with the device.

10. An apparatus for wireless communications, the apparatus comprising at least one processor, and at least one memory including computer program code, wherein the at least one memory and the computer program code are configured, with the at least one processor, to:
process information identifying at least one antenna beam used by an access point for wireless communication with a device, and
select, based at least in part on the information, at least one antenna beam for use in wireless communication between another access point and the device.

11. An apparatus according to claim 9, configured to generate and/or update a record associating antenna beams of at least two access points capable of communication with the device.

12. An apparatus according to claim 9, configured to handover the device between two access points and cause update of a record associating antenna beams of the two access points based on information of the handover.

13. An apparatus according to claim 11, wherein the record comprises a table linking beam identities of at least two neighbouring access points.

14. An apparatus according to claim 9, configured to communicate information identifying at least one antenna beam between a source access point and a target access point in association with a handover of the device between the source and target access points.

15. An apparatus according to claim 9, configured to cause selection of at least one antenna beam based on a record comprising information identifying antenna beams and associating at least one antenna beam of a source access point of a handover with at least one promising candidate antenna beam of a target access point.

16. An apparatus according to claim 9, wherein the access points are configured to operate in millimeter wave spectrum.

17. (canceled)

18. A communication device configured to communicate with at least one other node information identifying at least one antenna beam for use in antenna beam selection.

19. A communication device comprising:
at least one memory configured to store information of at least one antenna beam used for communication with a source access point involved in a handover of the communication device to a target access point, and
a processor configured to select at least one antenna beam for communication with a target access point based on the stored information.

20. A communication device according to claim 18 comprising a mobile station.

21. A communication device according to claim 18, comprising an active antenna array.

22-23. (canceled)

24. An apparatus according to claim 10, configured to handover the device between two access points and cause an update of a record associating antenna beams of the two access points based on information of the handover.

25. An apparatus according to claim 24, wherein the record comprises a table linking beam identities of at least two neighbouring access points.

26. An apparatus according to claim 10, configured to communicate information identifying at least one antenna beam between a source access point and a target access point in association with a handover of the device between the source and target access points.

27. An apparatus according to claim 10, configured to cause selection of at least one antenna beam based on a record comprising information identifying antenna beams and associating at least one antenna beam of a source access point of a handover with at least one promising candidate antenna beam of a target access point.

28. An apparatus according to claim 10, wherein the access points are configured to operate in millimeter wave spectrum.
